(19) United States
(12) Patent Application Publication
(10) Pub. No.: US 2011/0074792 A1
(43) Pub. Date: Mar. 31, 2011

(54) ULTRASONIC IMAGE PROCESSING SYSTEM AND ULTRASONIC IMAGE PROCESSING METHOD THEREOF

(76) Inventor: Pai-Chi LI, Taipei (TW)

(21) Appl. No.: 12/757,787

(22) Filed: Apr. 9, 2010

(30) Foreign Application Priority Data
Sep. 30, 2009 (TW) 098133234

(51) Int. Cl. G06F 13/14; G06T 1/00

(52) U.S. Cl. 345/519; 345/501

(57) ABSTRACT

An exemplary ultrasonic image processing system includes an ultrasonic transmitting apparatus, an ultrasonic receiving apparatus, a front-end processing circuit and a computer. The front-end processing circuit is electrically coupled to an ultrasonic probe through the ultrasonic transmitting apparatus and the ultrasonic receiving apparatus respectively. The computer is electrically coupled to the front-end processing circuit. The computer includes a central processing unit (CPU) and a graphics processing unit (GPU). The system employs the CPU to control the operations of the ultrasonic transmitting apparatus and the ultrasonic receiving apparatus through the front-end processing circuit, so as to acquire ultrasound scanning data. The system further employs the GPU to perform an image reconstruction process on the acquired ultrasound scanning data by way of multi-thread process, so as to generate an image display data. Moreover, a corresponding ultrasonic image processing method is also disclosed.

This application claims the priority benefit of Taiwan application serial no. 098133234, filed on Sep. 30, 2009.

### BACKGROUND

1. Field of the Invention

The invention generally relates to a medical technology and, more particularly, to an ultrasonic image processing system and an ultrasonic image processing method thereof.

2. Description of Prior Art

FIG. 1 shows a conventional ultrasonic image processing system. Referring to FIG. 1, a conventional ultrasonic image processing system 120 is electrically coupled to an ultrasonic probe 110 and a display apparatus 130. The ultrasonic image processing system 120 includes an ultrasonic transmitting apparatus 122, an ultrasonic receiving apparatus 124 and a processing chip 126. The ultrasonic transmitting apparatus 122 includes an ultrasonic transmitter 122-1 and a digital-analog (D-A) converter 122-2. The ultrasonic receiving apparatus 124 includes an ultrasonic receiver 124-1 and an analog-digital (A-D) converter 124-2.

The D-A converter 122-2 is used for converting the digital signal from the processing chip 126 into an analog signal to control the operation of the ultrasonic transmitter 122-1 accordingly, so that the ultrasonic transmitter 122-1 transmits an ultrasonic signal through the ultrasonic probe 110. The ultrasonic receiver 124-1 can receive a reflected signal of the ultrasonic signal through the ultrasonic probe 110. The A-D converter 124-2 converts the analog signal from the ultrasonic receiver 124-1 into a digital signal to acquire a digital ultrasound scanning data and transmit the acquired ultrasound scanning data to the processing chip 126. The processing chip 126 generates an image display data, so that the display apparatus 130 can display ultrasound scanning image.

Assuming that the processing chip 126 is used for generating a brightness mode image display data (i.e., B mode image display data), the processing chip 126 employs a hardware circuit therein to demodulate the received ultrasound scanning data and employs a software stored therein to further process the demodulated data when the processing chip 126 is processing an image, so as to generate a brightness mode image display data.

Furthermore, assuming that the processing chip 126 is used for generating a color Doppler mode image display data, the processing chip 126 employs a part of the hardware circuit arranged therein and a part of the software stored therein to generate a brightness mode image display data when the processing chip 126 is performing an image reconstruction process. At the same time, the processing chip 126 employs another part of the hardware circuit arranged therein to perform a color Doppler data demodulation on the received ultrasound scanning data and to filter noise signals. Then, the processing chip 126 further employs another part of the software stored therein to synthesize the processed color Doppler data and the brightness mode image display data and perform some post-processes, so as to generate a color Doppler mode image display data.

As stated above, the processing chip 126 needs to adopt different inner hardware circuits for different purposes and situations. Thus, the design of the processing chip 126 should be custom-made, which causes the high cost of the processing chip 126. In addition, as stated above, since the ultrasonic image processing system 120 still employs the custom-made hardware circuit arranged in the processing chip 126 to process data, the development of the ultrasonic image processing system 120 should be time-consuming. Furthermore, since the design of the hardware circuit arranged in the processing chip 126 is difficult to be modified, the function extension of the ultrasonic image processing system 120 is worse.

In U.S. Pat. No. 7,052,460, the technology of a processing chip performing a data process through a custom-made hardware circuit therein is also disclosed. It is obvious that the processing chip in this prior art has disadvantages of being difficult to develop, worse performance of function extension and high cost.

### BRIEF SUMMARY

An objective of the invention is to provide an ultrasonic image processing system, an inner hardware circuit arranged therein can be custom-made for different purposes and situations, the development thereof is simple and the technology extension is easy.

Another objective of the invention is to provide an ultrasonic image processing method corresponding to the above ultrasonic image processing system.

Other objectives, features and advantages of the invention will be further understood from the further technological features disclosed by the embodiments of the invention wherein there are shown and described preferred embodiments of this invention, simply by way of illustration of modes best suited to carry out the invention.

For at least one, a part, or all of above objectives, in accordance with an embodiment of the invention, an ultrasonic image processing system comprises an ultrasonic transmitting apparatus, an ultrasonic receiving apparatus, a front-end processing circuit and a computer. The front-end processing circuit is electrically coupled to the ultrasonic probe through the ultrasonic transmitting apparatus and the ultrasonic receiving apparatus respectively. The computer comprises a graphics processing unit and a central processing unit. The graphics processing unit is electrically coupled to the front-end processing circuit, and the central processing unit is electrically coupled to the graphics processing unit. The central processing unit is used for acquiring ultrasound scanning data from the ultrasonic probe through the front-end processing circuit. The central processing unit controls the graphics processing unit to perform an image reconstruction process on the acquired ultrasound scanning data by a way of multi-thread process, so as to generate an image display data.

In accordance with another embodiment, an ultrasonic image processing method is disclosed. The ultrasonic image processing method is suitable for the aforementioned ultrasonic image processing system. The ultrasonic image processing system comprises an ultrasonic transmitting apparatus, an ultrasonic receiving apparatus, a front-end processing circuit and a computer. The front-end processing circuit is electrically coupled to the ultrasonic probe through the ultrasonic transmitting apparatus and the ultrasonic receiving apparatus respectively. The computer comprises a graphics processing unit and a central processing unit, wherein the graphics processing unit is electrically coupled to the front-end processing circuit and the central processing unit. The ultrasonic image processing method comprises the following steps: employing the central processing unit to acquire ultrasound scanning data from the ultrasonic probe through the front-end processing circuit; and employing the central processing unit to control the graphics processing unit to perform an image reconstruction process on the acquired ultrasound scanning data by a way of multi-thread process, so as to generate an image display data.

In above embodiments, the ultrasonic image processing system performs an image reconstruction process through an original framework of the computer cooperating with corresponding software, and a simple front-end processing circuit can also be adopted. Thus, the inner hardware circuit of the ultrasonic image processing system can be used without large modification for different purposes, so that the cost of the ultrasonic image processing system is relatively low. In addition, since a part of the software can be modified for different purposes to meet different requirements of users, the development of the above ultrasonic image processing system is simple, and the function extension of the ultrasonic image processing system is better.

For above and another objectives, features, and effects of the invention being better understood and legibly, accompanying embodiments together with the drawings are particularized.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a conventional ultrasonic image processing system;

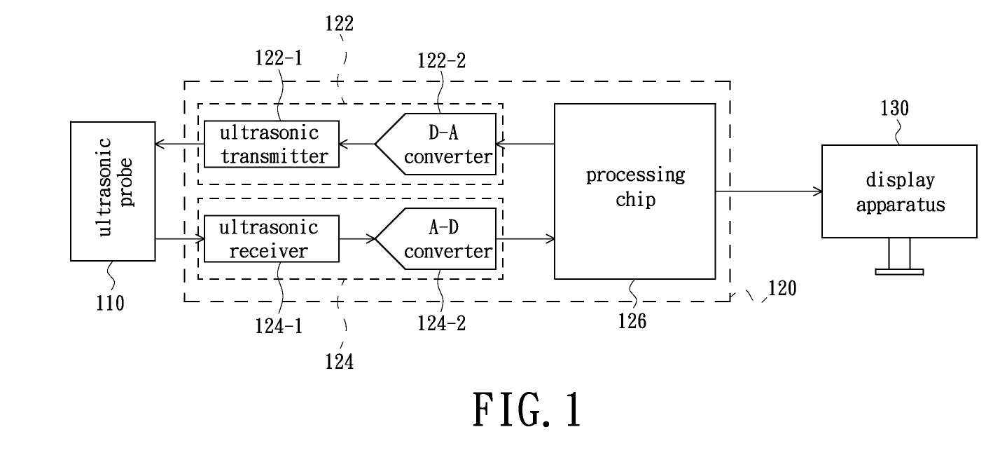

FIG. 2 shows an ultrasonic image processing system in accordance with an embodiment of the invention;

FIG. 3 shows an ultrasonic image processing system in accordance with an embodiment of the invention;

FIG. 4 shows an ultrasonic image processing system in accordance with an embodiment of the invention;

FIG. 5 shows an ultrasonic image processing system in accordance with an embodiment of the invention; and

FIG. 6 shows an ultrasonic image processing method in accordance with an embodiment of the invention.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### A First Embodiment

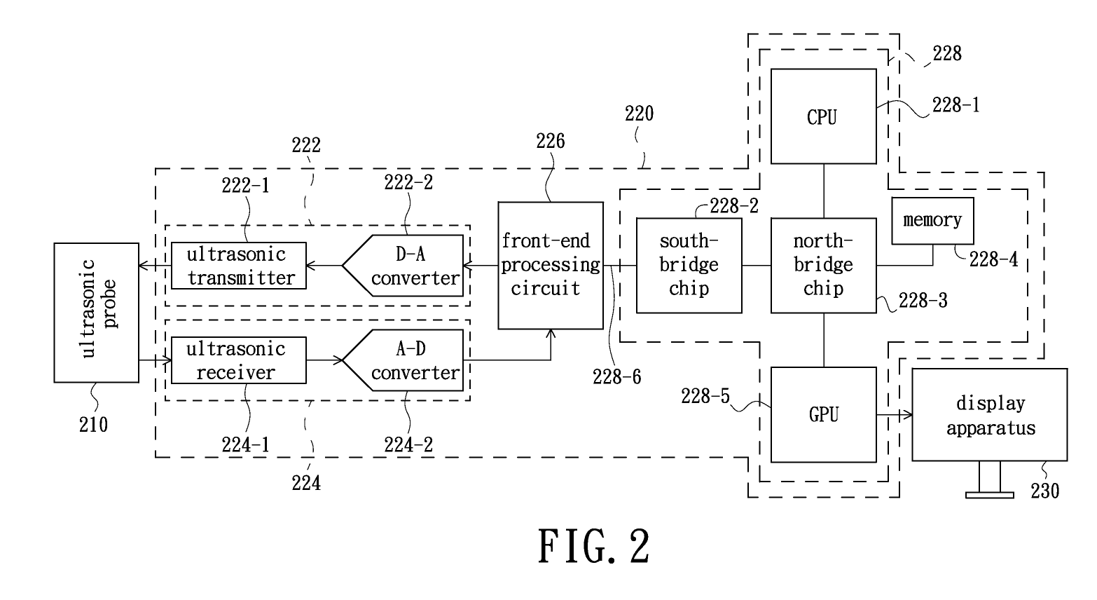

FIG. 2 shows an ultrasonic image processing system in accordance with an embodiment of the invention. As shown in FIG. 2, an ultrasonic image processing system 220 is electrically coupled to an ultrasonic probe 210 and a display apparatus 230. The ultrasonic image processing system 220 includes an ultrasonic transmitting apparatus 222, an ultrasonic receiving apparatus 224, a front-end processing circuit 226 and a computer 228. The front-end processing circuit 226 is electrically coupled to the ultrasonic probe 210 through the ultrasonic transmitting apparatus 222 and the ultrasonic receiving apparatus 224 respectively.

The ultrasonic transmitting apparatus 222 includes an ultrasonic transmitter 222-1 and a digital-analog (D-A) converter 222-2. The ultrasonic receiving apparatus 224 includes an ultrasonic receiver 224-1 and an analog-digital (A-D) converter 224-2. The D-A converter 222-2 is used for converting the digital signal from the front-end processing circuit 226 into an analog signal to control the operation of the ultrasonic transmitter 222-1 accordingly, so that the ultrasonic transmitter 222-1 transmits ultrasonic signal through the ultrasonic probe 210. The ultrasonic receiver 224-1 is used for receiving a reflected signal of the above ultrasonic signal through the ultrasonic probe 210. The A-D converter 224-2 is used for converting the analog signal from the ultrasonic receiver 224-1 into a digital signal to acquire a digital ultrasound scanning data and to transmit the acquired ultrasound scanning data to the front-end processing circuit 226. Thus, the ultrasonic probe 210 can be employed to transmit the ultrasonic signal provided by the ultrasonic transmitting apparatus 222 controlled by the front-end processing circuit 226 to an object (not shown), and the ultrasonic probe 210 receives a reflected signal of the above ultrasonic signal generated in the object. The reflected signal is so called an ultrasound scanning data. The ultrasound scanning data is transmitted to the front-end processing circuit 226 through the ultrasonic receiving apparatus 224, and the ultrasound scanning data is further transmitted to the computer 228 to be processed.

The computer 228 includes a central processing unit (CPU) 228-1, a south-bridge chip 228-2, a north-bridge chip 228-3, a memory 228-4 and a graphics processing unit (GPU) 228-5. In the embodiment, the GPU 228-5 can exemplarily be a GPU with model of GTX295 or 9800GT produced by NVIDIA Corporation, but the invention is not limited by the GPU GTX295 or GPU 9800GT. The memory 228-4 can exemplarily be a double-data-rate two synchronous dynamic random access memory (DDR2 SDRAM), a double-data-rate three synchronous dynamic random access memory (DDR3 SDRAM) or a double-data-rate four synchronous dynamic random access memory (DDR4 SDRAM). The memory 228-4 is not limited by above-mentioned memories.

In addition, in the embodiment the south-bridge chip 228-2 is electrically coupled to the front-end processing circuit 226 through a high speed data bus 228-6. The high speed data bus 228-6 can be a peripheral component interconnect express (PCI-E) bus. Certainly, the high speed data bus 228-6 can also be a serial advanced technology attachment (SATA) bus or a USB (universal serial bus) 3.0. The north-bridge chip 228-3 is electrically coupled to the CPU 228-1, the south-bridge chip 228-2, the memory 228-4 and the GPU 228-5.

The CPU 228-1 controls the operations of the ultrasonic transmitting apparatus 222 and the ultrasonic receiving apparatus 224 through the front-end processing circuit 226, so that the front-end processing circuit 226 can acquire ultrasound scanning data through the ultrasonic receiving apparatus 224 and store the ultrasound scanning data to the memory 228-4 by the way of direct memory access (DMA). In addition, the CPU 228-1 also employs the GPU 228-5 to acquire the ultrasound scanning data stored in the memory 228-4 by the way of DMA, and the CPU 228-1 further employs the GPU 228-5 to perform an image reconstruction process on the acquired ultrasound scanning data by a way of multi-thread process to generate an image display data. Thus, the display apparatus 230 can display an ultrasound scanning image according to the image display data.

The GPU 228-5 is used for generating a brightness mode image display data, the CPU 228-1 employs a corresponding software to control the GPU 228-5 to demodulate the received ultrasound scanning data and further employs the corresponding software to perform some post-processes on the demodulated data when the GPU 228-5 is performing an image reconstruction process, so as to generate a brightness mode image display data.

Furthermore, the GPU 228-5 is used for generating a color Doppler mode image display data, the CPU 228-1 employs a part of the corresponding software to control the GPU 228-5 to generate a brightness mode image display data when the GPU 228-5 is performing an image reconstruction process. At the same time, the CPU 228-1 employs another part of the above corresponding software to control the GPU 228-5 to perform a color Doppler data demodulation on the received ultrasound scanning data and to filter noise signals. Then, the CPU 228-1 further employs a third part of the corresponding software to control the GPU 228-5 to synthesize the processed color Doppler data and the brightness mode image display data and perform some post-processes, so as to generate a color Doppler mode image display data.

It is noted that the operating frequency bandwidth of the ultrasonic image processing system is up to 122.88 MB/s. Therefore, a PCI-E interface is adopted as a data transmitting interface of the system. Thus, when the ultrasonic image processing system adopts one lane transmitting mode or several lanes transmitting mode, the ultrasonic image processing system may has a transmitting frequency bandwidth of 250 MB/s or more. Hence, the ultrasonic image processing system can transmit data in a high speed.

Based on the above description, it is understood that in this embodiment the image reconstruction process is mainly performed by an original framework of the computer cooperating with corresponding software. Due to the GPU for performing an image reconstruction process is a multi-core parallel operation unit, the image reconstruction process can be divided into a plurality of sub-processes and the sub-processes can be assigned to different cores to be processed synchronously. Thus, the processing speed is accelerated, and the processing speed is high enough for a mass of image data. In addition, for different image reconstruction manners, even for different demodulation manners, the corresponding software of the ultrasonic image processing system 220 in the above embodiment can be modified, and a simple front-end processing circuit 226 can be adopted in the ultrasonic image processing system 220. Thus, the cost of the ultrasonic image processing system 220 in the above embodiment is relatively low. Furthermore, since a part of the corresponding software can be modified for different purposes to meet different requirements of users, the development of the ultrasonic image processing system 220 is easy, and the function extension of the ultrasonic image processing system 220 is better.

### A Second Embodiment

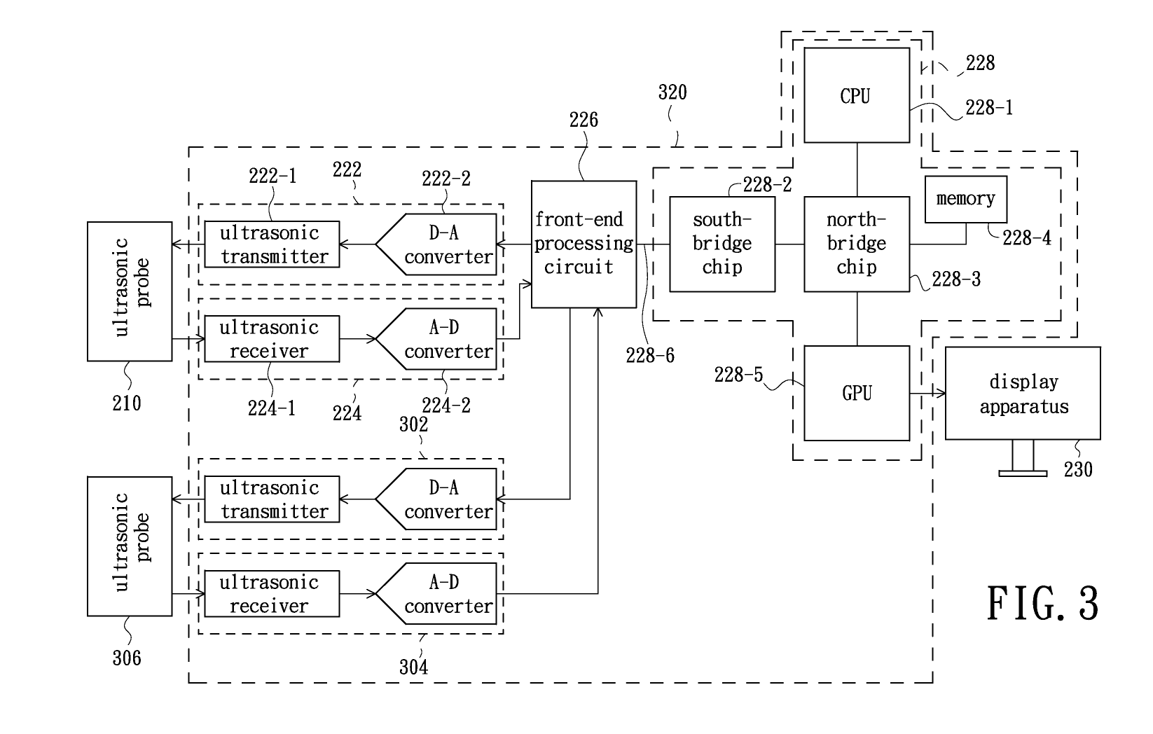

FIG. 3 shows an ultrasonic image processing system in accordance with an embodiment of the invention. As shown in FIG. 3, the ultrasonic image processing system 320 compares with the ultrasonic image processing system 220 shown in FIG. 2, the ultrasonic image processing system 320 additionally includes an ultrasonic transmitting apparatus 302 and an ultrasonic receiving apparatus 304. The ultrasonic transmitting apparatus 302 and the ultrasonic receiving apparatus 304 are electrically coupled to the ultrasonic probe 306 and are further electrically coupled to the front-end processing circuit 226. Thus, a user can perform an operation with two or more ultrasonic probes. In other words, the front-end processing circuit 226 can also be electrically coupled to a plurality of probes arranged in array. The arrangement of the probes is not a limitation.

### A Third Embodiment

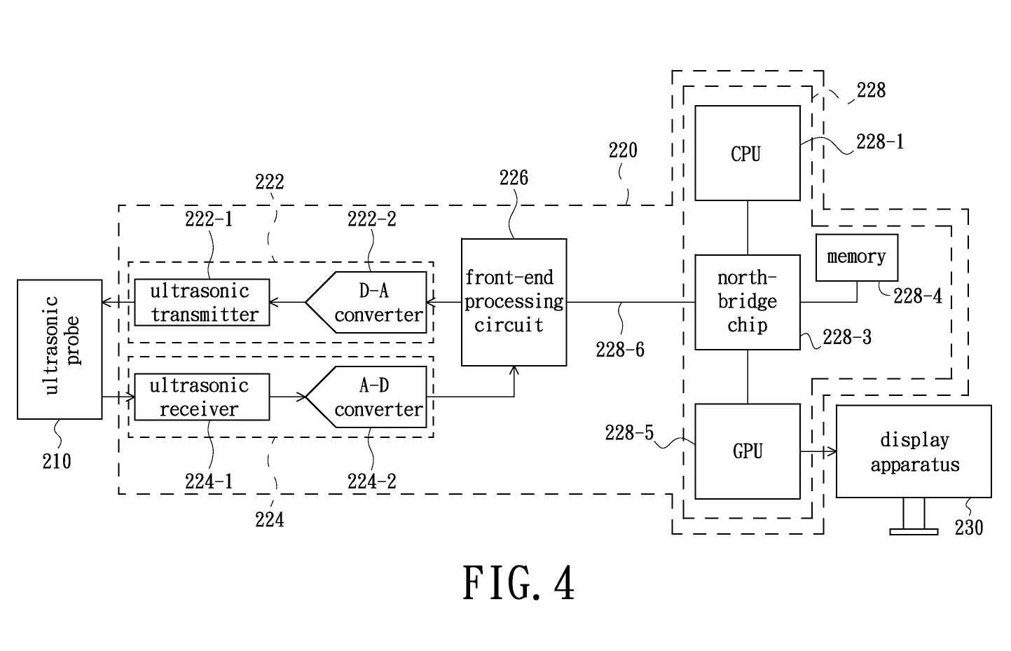

FIG. 4 shows an ultrasonic image processing system in accordance with an embodiment of the invention. The difference between this embodiment and the first embodiment is that the north-bridge chip 228-3 of the computer 228 shown in FIG. 4 is electrically coupled to the front-end processing circuit 226 directly through the high speed data bus 228-6.

### A Fourth Embodiment

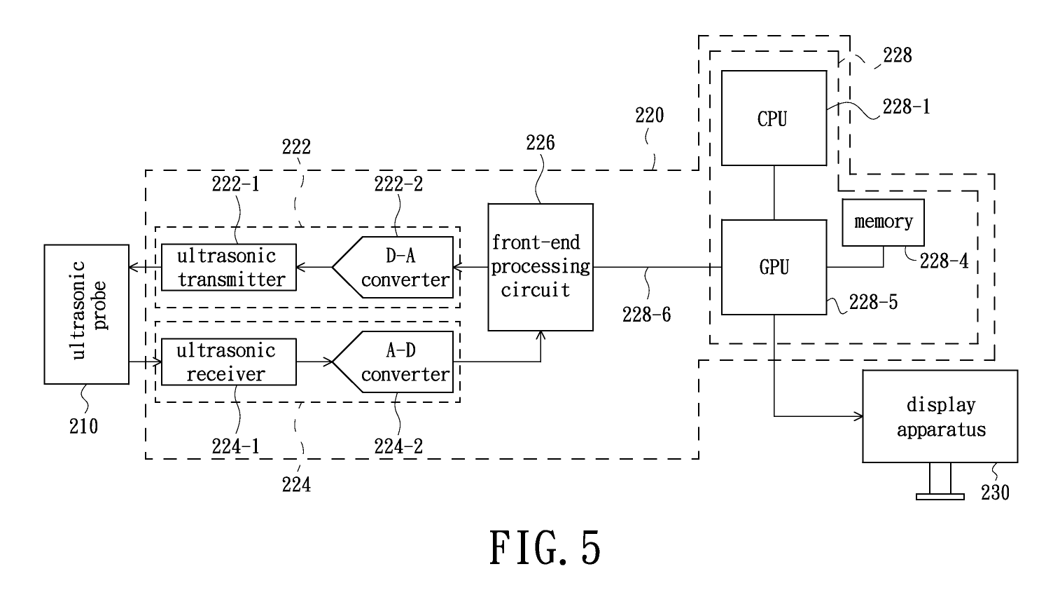

FIG. 5 shows an ultrasonic image processing system in accordance with an embodiment of the invention. The difference between this embodiment and the first embodiment is that the GPU 228-5 of the computer 228 shown in FIG. 5 is electrically coupled to the CPU 228-1 and the memory 228-4 directly, and the GPU 228-5 is electrically coupled to the front-end processing circuit 226 directly through the high speed data bus 228-6. If the GPU 228-5 shown in FIG. 5 has enough memory capacity itself, the memory 228-4 can be omitted.

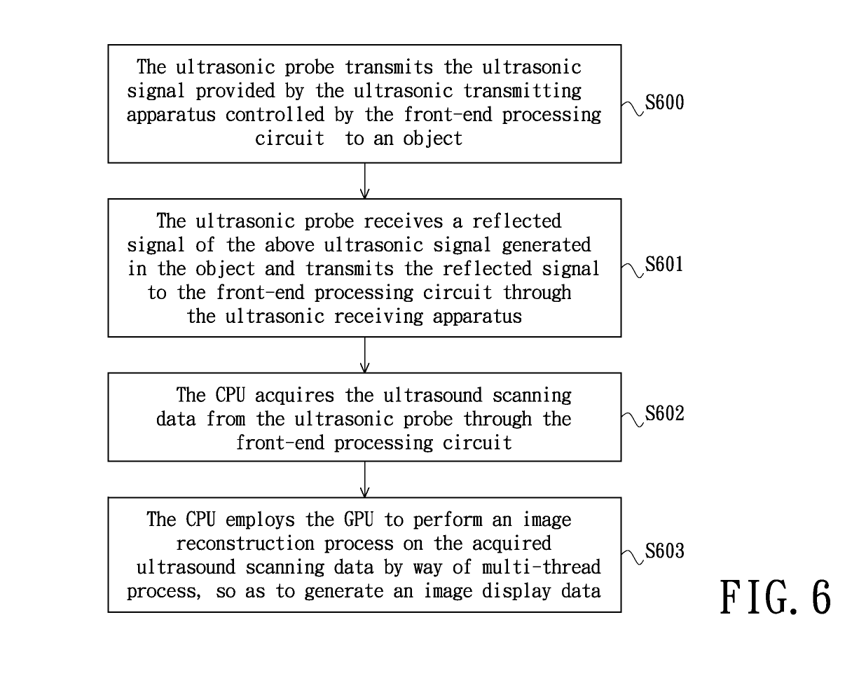

As shown in FIG. 6, an essential operation method is concluded based on above embodiments. FIG. 6 shows a processing diagram of an ultrasonic image processing method in accordance with an embodiment of the invention. The ultrasonic image processing method is suitable for an ultrasonic image processing system. The ultrasonic image processing system includes an ultrasonic transmitting apparatus, an ultrasonic receiving apparatus, a front-end processing circuit and a computer. The front-end processing circuit is electrically coupled to the ultrasonic probe through the ultrasonic transmitting apparatus and the ultrasonic receiving apparatus respectively. The computer includes a GPU and a CPU, wherein the GPU is electrically coupled to the front-end processing circuit and the CPU. In the ultrasonic image processing method, the ultrasonic probe transmits the ultrasonic signal provided by the ultrasonic transmitting apparatus controlled by the front-end processing circuit to an object firstly (step S600), and then the ultrasonic probe receives a reflected signal (i.e., an ultrasound scanning data) of the above ultrasonic signal generated in the object and transmits the ultrasound scanning data to the front-end processing circuit through the ultrasonic receiving apparatus (step S601). After that, the CPU acquires the ultrasound scanning data from the ultrasonic probe through the front-end processing circuit (step S602). The CPU employs the GPU to perform an image reconstruction process on the acquired ultrasound scanning data by the way of multi-thread process, so as to generate an image display data (step S603).

As stated above, in above embodiments the ultrasonic image processing system performs an image reconstruction process through an original framework of the computer cooperating with corresponding software, and a simple front-end processing circuit 226 can also be adopted. Thus, the inner hardware circuit of the ultrasonic image processing system can be used for different purposes and situations without large modification. Thus, the cost of the ultrasonic image processing system is relatively low. In addition, since a part of the corresponding software can be modified for different purposes to meet different requirements of users, the development of the above ultrasonic image processing system is easy, and the function extension of the ultrasonic image processing system is better.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. An ultrasonic image processing system, comprising:
an ultrasonic transmitting apparatus;
an ultrasonic receiving apparatus;
a front-end processing circuit electrically coupled to an ultrasonic probe through the ultrasonic transmitting apparatus and the ultrasonic receiving apparatus respectively; and
a computer, comprising:
a graphics processing unit electrically coupled to the front-end processing circuit; and
a central processing unit electrically coupled to the graphics processing unit and being used for acquiring an ultrasound scanning data from the ultrasonic probe through the front-end processing circuit; wherein the central processing unit is used for controlling the graphics processing unit to perform an image reconstruction process on the acquired ultrasound scanning data by a way of multi-thread process, so as to generate an image display data.

2. The ultrasonic image processing system as claimed in claim 1, wherein the computer further comprises:
a north-bridge chip, wherein the graphics processing unit is electrically coupled to the front-end processing circuit and the central processing unit through the north-bridge chip.

3. The ultrasonic image processing system as claimed in claim 2, wherein the computer further comprises:
a south-bridge chip, electrically coupled between the north-bridge chip and the front-end processing circuit.

4. The ultrasonic image processing system as claimed in claim 3, wherein the computer further comprises:
a memory, electrically coupled to the north-bridge chip, wherein the central processing unit is used for controlling the front-end processing circuit, so as to store the ultrasound scanning data to the memory by way of direct memory access.

5. The ultrasonic image processing system as claimed in claim 4, wherein the central processing unit is used for controlling the graphics processing unit to acquire the ultrasound scanning data stored in the memory by a way of direct memory access.

6. The ultrasonic image processing system as claimed in claim 4, wherein the memory is a double-data-rate two synchronous dynamic random access memory, a double-data-rate three synchronous dynamic random access memory, or a double-data-rate four synchronous dynamic random access memory.

7. The ultrasonic image processing system as claimed in claim 3, wherein the south-bridge chip is electrically coupled to the front-end processing circuit through a high speed data bus.

8. The ultrasonic image processing system as claimed in claim 7, wherein the high speed data bus is a peripheral component interconnect express bus, a serial advanced technology attachment bus or an universal serial bus 3.0.

9. The ultrasonic image processing system as claimed in claim 1, wherein the ultrasonic transmitting apparatus comprises:
an ultrasonic transmitter; and
a digital-analog converter used for converting a digital signal from the front-end processing circuit into an analog signal, so as to control the operation of the ultrasonic transmitter accordingly.

10. The ultrasonic image processing system as claimed in claim 1, wherein the ultrasonic receiving apparatus comprises:
an ultrasonic receiver; and
an analog-digital converter used for converting an analog signal from the ultrasonic receiver into a digital signal, so as to acquire a digital ultrasound scanning data and transmit the acquired digital ultrasound scanning data to the front-end processing circuit.

11. The ultrasonic image processing system as claimed in claim 1, wherein the graphics processing unit is further electrically coupled to a display apparatus, the display apparatus is used for displaying an ultrasound scanning image according to the image display data.

12. An ultrasonic image processing method for an ultrasonic image processing system, the ultrasonic image processing system comprising an ultrasonic transmitting apparatus, an ultrasonic receiving apparatus, a front-end processing circuit and a computer, the front-end processing circuit being electrically coupled to an ultrasonic probe through the ultrasonic transmitting apparatus and the ultrasonic receiving apparatus respectively, the computer comprising a graphics processing unit and a central processing unit, the graphics processing unit being electrically coupled to the front-end processing circuit and the central processing unit, the ultrasonic image processing method comprising the steps of:
employing the central processing unit to acquire a ultrasound scanning data from the ultrasonic probe through the front-end processing circuit; and
employing the central processing unit to control the graphics processing unit to perform an image reconstruction process on the acquired ultrasound scanning data by a way of multi-thread process, so as to generate an image display data.

13. The ultrasonic image processing method as claimed in claim 12, wherein the graphics processing unit is further electrically coupled to a display apparatus, the ultrasonic image processing method further comprises:
employing the display apparatus to display an ultrasound scanning image according to the image display data.

14. The ultrasonic image processing method as claimed in claim 12, wherein the computer further comprises a north-bridge chip, a south-bridge chip and a memory, the graphics processing unit is electrically coupled to the central processing unit, the south-bridge chip and the memory through the north-bridge chip, the south-bridge chip is electrically coupled between the north-bridge chip and the front-end processing circuit, the ultrasonic image processing method further comprises:
employing the central processing unit to control the front-end processing circuit, so as to store the ultrasound scanning data to the memory by a way of direct memory access.

15. The ultrasonic image processing method as claimed in claim 14, further comprising:
employing the central processing unit to control the graphics processing unit to acquire the ultrasound scanning data stored in the memory by the way of direct memory access.
